(19) United States
(12) Patent Application Publication
(10) Pub. No.: US 2013/0326342 A1
(43) Pub. Date: Dec. 5, 2013

(54) OBJECT SCALABILITY AND MORPHING AND TWO WAY COMMUNICATION METHOD

(71) Applicants: Remon Tijssen, Mill Valley, CA (US); Aaron D. Munter, San Francisco, CA (US)

(72) Inventors: Remon Tijssen, Mill Valley, CA (US); Aaron D. Munter, San Francisco, CA (US)

(73) Assignee: Adobe Systems Incorporated, San Jose, CA (US)

(21) Appl. No.: 13/489,296

(22) Filed: Jun. 5, 2012

(51) Int. Cl. G06F 17/00

(52) U.S. Cl. 715/251

(57) ABSTRACT

In various example embodiments, a system and method for providing scalability and morphing for transitions between states of a user interface are provided. In example embodiments, a request to transition from a departure state of a first page of the user interface to a destination state of a second page of the user interface is received. A plurality of elements and element attributes within the departure state and the destination state are identified. For each of the elements, a transition mechanism to be applied to an element to transition to the destination state is determined. The transition to the destination state is automatically generated by applying, for each of the elements, the determined transition mechanism.

### FIELD

The present disclosure relates generally to visual displays, and in a specific example embodiment, to object scalability and morphing in transitions.

### BACKGROUND

Conventionally, information provided via a user interface comprises static HTML pages. For example, a user may view a form and select a button on the form. Subsequently, the user is taken out of a first page displaying the form and shown a new static page. As a result, the user must refocus to the content of the new page.

In terms of developing transitions between these pages in the conventional system, a developer must individually create transitions between all possible page changes. For example, the first page may provide six selectable buttons. Each button may take the user to a different page. As a result, the developer will need to create a power of that number of possible page transitions (i.e., 6×6=36). In this example, 36 transitions will need to be manually coded by the developer to account for all possible transactions associated with the first page.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to provide object scalability and morphing in transitions.

FIG. 2 is a block diagram illustrating an example embodiment of a transition management system.

FIG. 3a is a screen shot of a result page of an example user interface for products.

FIG. 3b is a screen shot of a small display page of the example user interface for the products.

FIG. 3c is a screen shot of a comparison page of the example user interface for the products.

FIG. 3d is a screen shot of a full information page of the example user interface for a particular product.

FIG. 3e is a screen shot of a page of a user interface having live communication.

FIG. 4 is a flow diagram of an example high-level method for providing object scalability and morphing according to example embodiments.

FIG. 5 is a flow diagram of an example method for providing a transition to a new state.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for managing transitions in communications. In example embodiments, the transitions are between pages of a user interface. Each page comprises a plurality of elements which may be, for example, a component, a widget, a user interface control, a layer, a group, a graphic icon, text, or any other item found on the page which may be transitioned. A configuration of a group of these elements is referred to as the page of the user interface, and a state is an expression of the page. A change from one page to a next page is referred to as a transition from a departure page to a destination page. As such, a change from one state of a page to a next state may be referred to a transition from a departure state to a destination state.

Transition mechanisms to provide the transitions may include animations or other visual or audio effects, may replace one element with another element, or may place an element in one condition into a different condition. Additionally, a transition mechanism may trigger an action or other sequence of events not visible or audible to the user. A visual effect is a visually perceptible attribute associated with an element. An audio effect is an attribute associated with an element having audio characteristics. For illustrative purposes only, visual effects will be referenced herein. Example visual effects include a move effect, a wipe effect, a resize effect, a fade-in effect, a fade-out effect, or some other suitable effect. These visual effects may occur over time or due to the occurrence of an event.

Each transition between states of pages does not simply imply a change of state, but also defines these transition mechanisms. As such, a transition mechanism is an action that is performed on an element to transition the element to the new state. For example, in transition from one state to another, a first element may fly into view (e.g., from a left side) while another element flies from view (e.g,, from a right side). Alternatively, elements may slide across or around the screen or have some other behavior. Other transition mechanisms may include a resize effect, a bold effect (e.g., bold or unbold of text), a font change effect, or any other visually detectable change to the element.

In example embodiments, a request to transition from a departure state of a first page of the user interface to a destination state of a second page of the user interface is received. The request identifies the first page and the second page. The departure state is astute corresponding to the first page from which the user interface is transitioning, while the destination state corresponds to the second page to which the user interface is transitioning. Accordingly, a state database may be accessed to determine a plurality of elements and corresponding element attributes within the departure state and the destination state. The element attributes are characteristics associated with the element. Example element attributes may comprise a size of each element and a location of each element.

For each of the elements, a transition mechanism to be applied to an element to transition to the destination state is determined. The transition mechanism may be determined by accessing a rules database that includes rules for transitioning the element to the destination state. Furthermore, a user may modify application of a rule from the rules database. The transition to the destination state is automatically generated by applying, for each of the elements, the determined transition mechanism.

By using embodiments of the present invention, a developer may more quickly and easily develop user interfaces simply by creating pages of the user interface. Subsequently, transitions between states of pages may be automatically, without user intervention, generated. Accordingly, one or more of the methodologies discussed herein may obviate a need for prolonged programming involved in developing the user interface including the transitions, which may have the technical effect of reducing computing resources used by one or more devices within the system to develop the user interfaces. Examples of such computing resources include, without limitation, processor cycles, network traffic, memory usage, storage space, and power consumption.

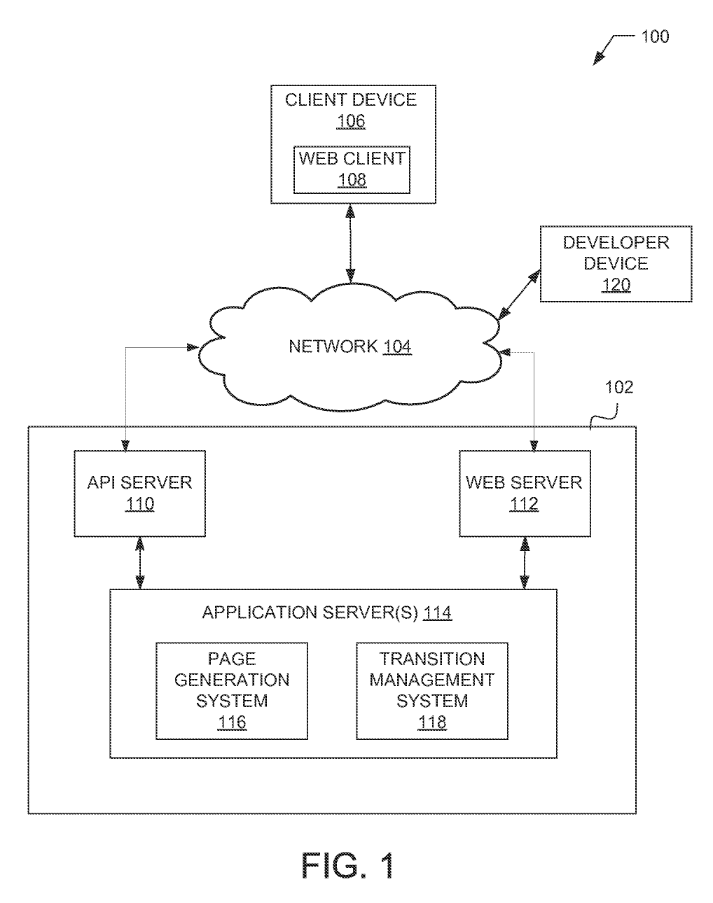

With reference to FIG. 1, an example embodiment of a high-level client-server-based network architecture 100 in which embodiments of the present invention may be utilized is shown. A networked system 102, in an example form of a network-server-side functionality, is coupled via a communication network 104 (e.g., the Internet, wireless network, cellular network, Local Area Network (LAN), or a Wide Area Network (WAN)) to one or more client devices 106. FIG. 1 illustrates, for example, a web client 108 operating via a browser (e.g., such as the Internet Explorer® browser developed by Microsoft® Corporation of Redmond, Wash. State) on the client device 106. Alternatively, a programmatic client (not shown) may execute on the client device 106.

The client device 106 may comprise a mobile phone, desktop computer, laptop, or any other communication device that a user may utilize to access the networked system 102. In some embodiments, the client device 106 may comprise a display module (not shown) to display information (e.g., in the form of pages of a user interface). In further embodiments, the client device 106 may comprise one or more of a touch screen, camera, and microphone. The client device 106 may be used by a user to view and interact with the pages of the user interface provided by the networked system 102.

An Application Program Interface (API) server 110 and a web server 112 are coupled to, and provide programmatic and web interfaces respectively to, one or more application servers 114. The application servers 114 may host a page generation system 116 and a transition management system 118, which may comprise one or more modules, applications, or engines, and may be embodied as hardware, software, firmware, or any combination thereof. The application servers 114 may be coupled to one or more database servers (not shown) facilitating access to one or more information storage repositories or database(s). In one embodiment, the databases are storage devices that store information used by the page generation system 116 and the transition management system 118.

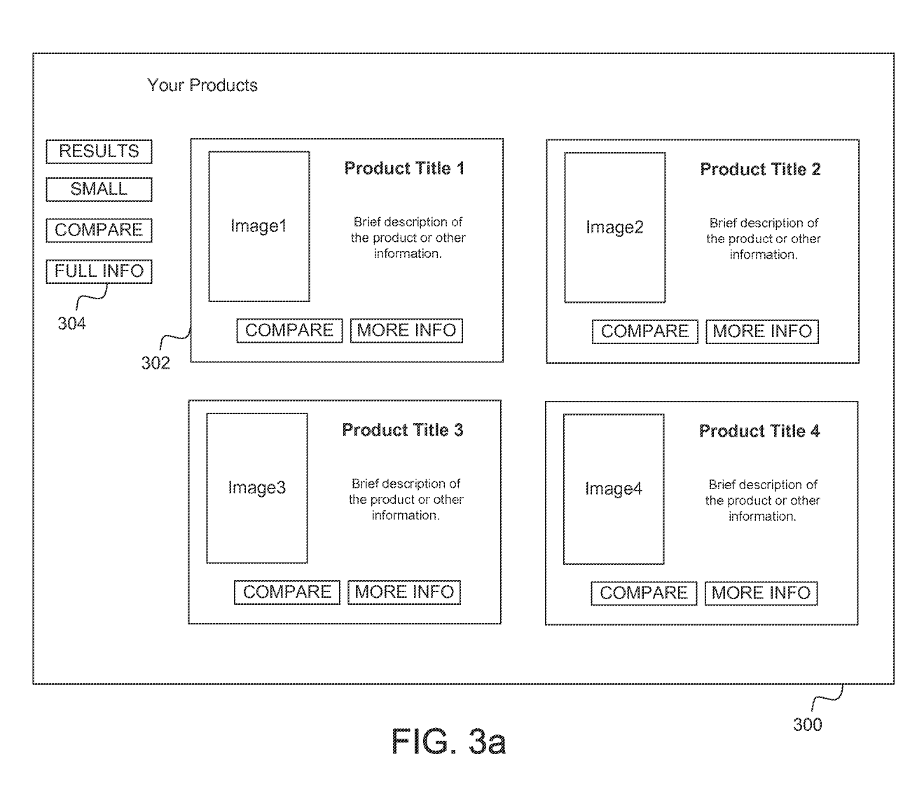

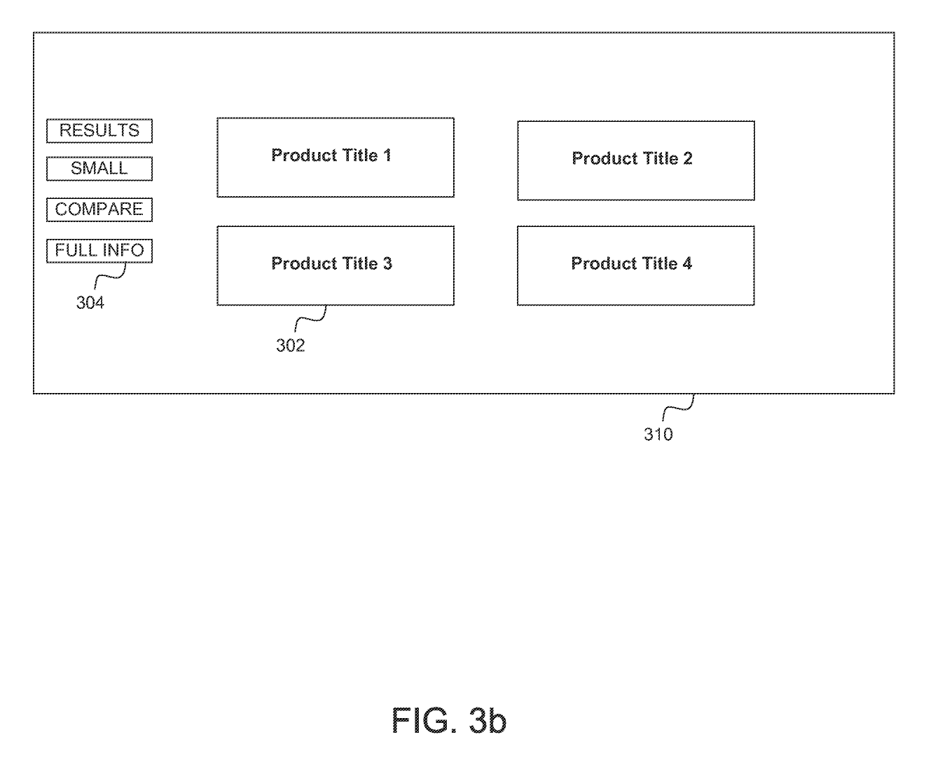

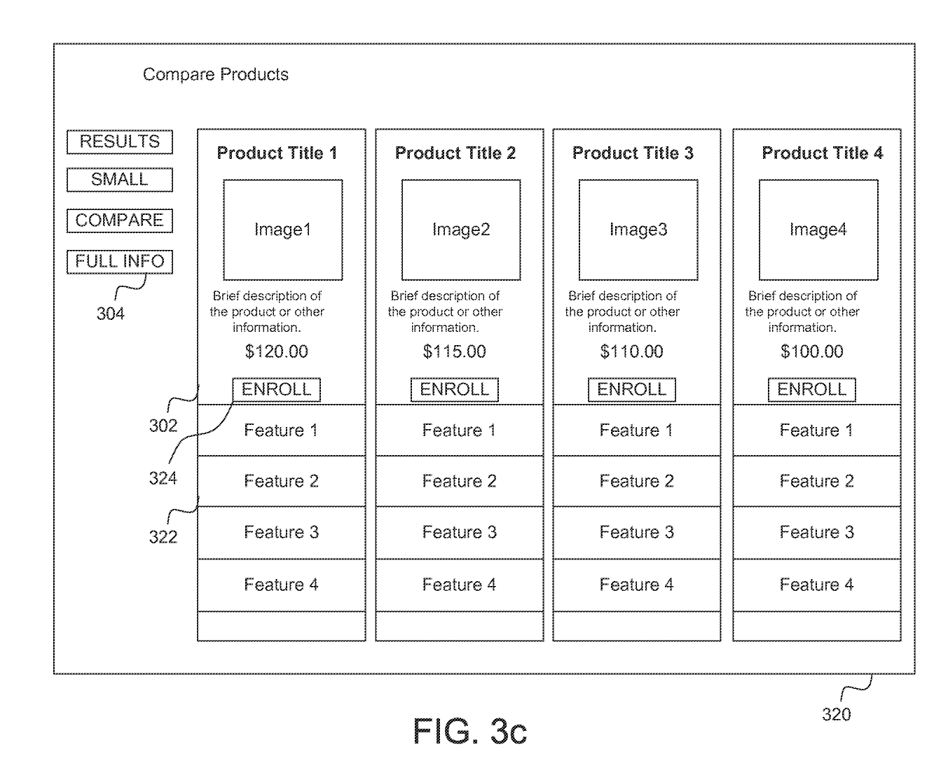

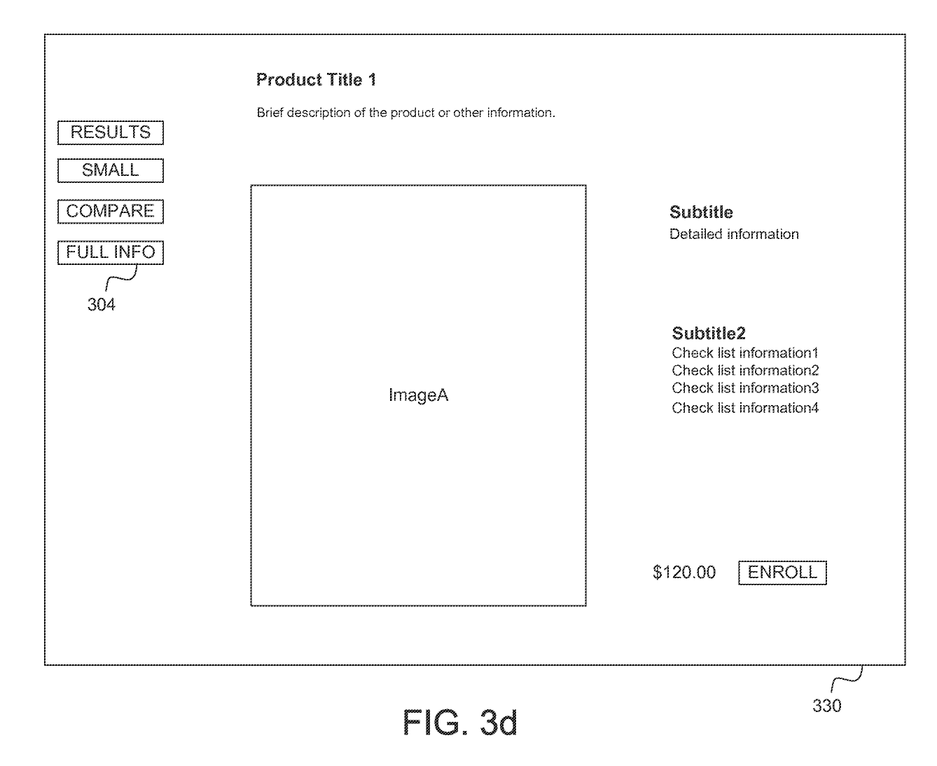

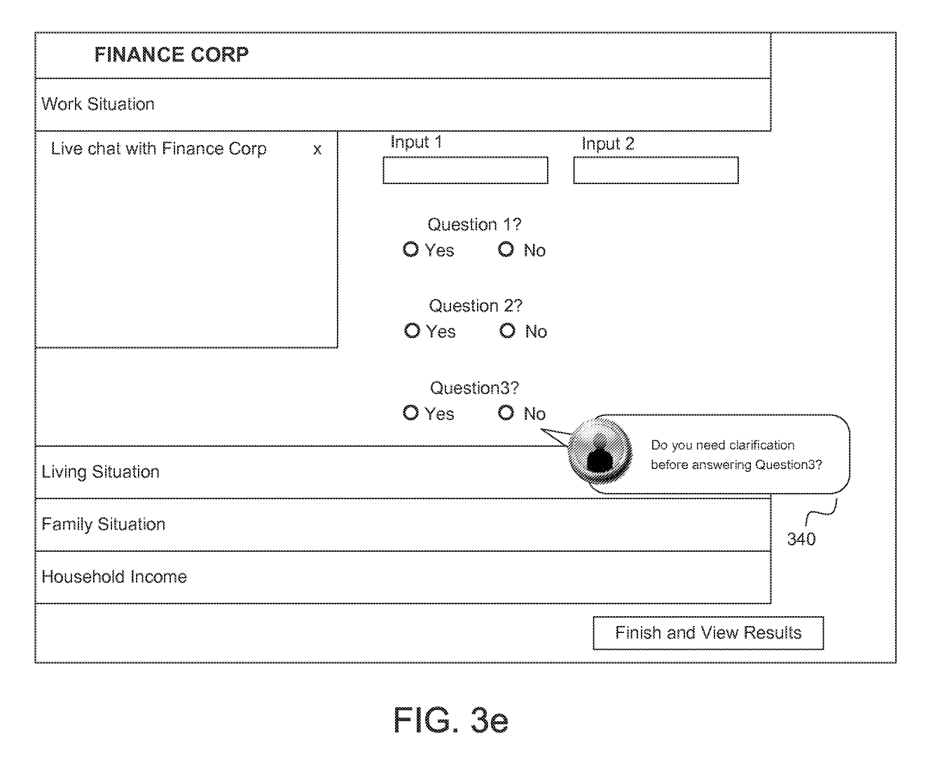

In one embodiment, a developer at a developer device 120 creates pages of a user interface. Accordingly, the page generation system 116 enables the user to generate the pages. These pages are generally static pages. The page generation system 116 may include a drawing application such as, for example, Adobe® Illustrator® or Adobe® Photoshop®. Using the drawing application, the developer may create each page of the user interface by placing various elements each having a particular size in a specific location. These elements may comprise, for example, titles, descriptions, photos, images, selectable buttons, or any other object that may be placed on a page of the user interface. Pages of an example user interface are discussed in more detail in connection with FIG. 3.

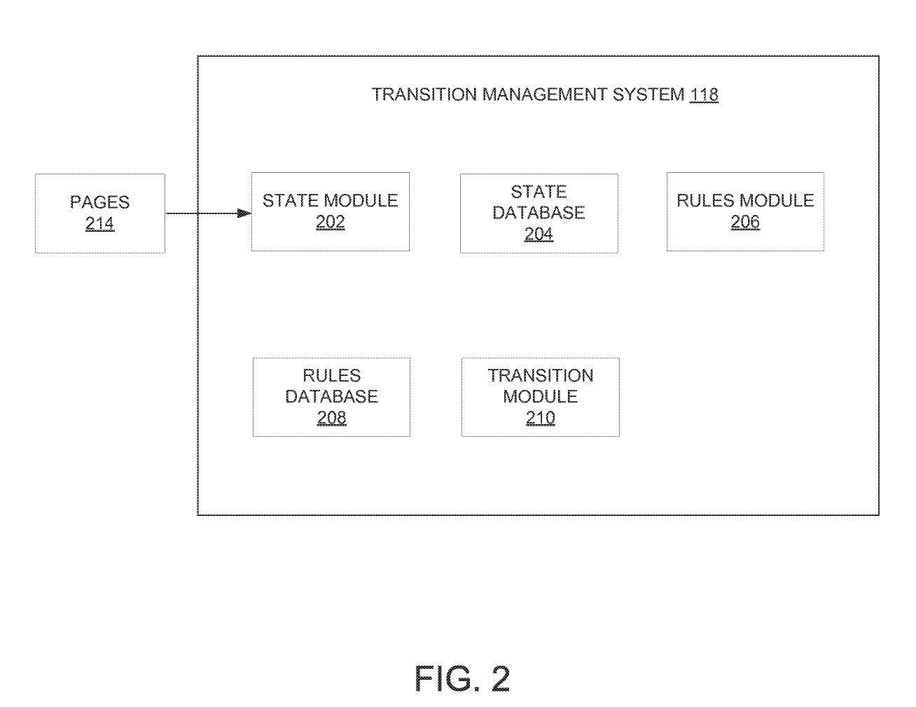

Once the pages are generated, the pages may be exported or otherwise provided to the transition management system 118. The transition management system 118 automatically generates the transitions between these static pages. In example embodiments, the transition management system 118 determines the various elements and their attributes within each state of the user interface (e.g., a page). Based on the elements, their attributes, and a set of rules for transitioning between states, the transition management system 118 automatically creates transitions between the states without requiring any programming by the developer of the developer device 120. In one embodiment, the page generation system 116 may be embodied within the transition management system 118. In another embodiment, the page generation system 116 or the transition management system 118 may be a part of the developer device 120. The transition management system 118 will be discussed in more detail in connection with FIG. 2 below.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The transition management system 118 as well as the page generation system 116 may also be implemented as standalone systems or standalone software programs operating under a separate hardware platform, which does not necessarily have networking capabilities.

Referring now to FIG. 2, an example block diagram illustrating multiple components that, in one embodiment, are provided within the transition management system 118 is shown. In example embodiments, the transition management system 118 comprises a state module 202, a state database 204, a rules module 206, a rules database 208, and a transition module 210. In some embodiments, the transition management system 118 receives generated pages 214 of a user interface. For example, the generated pages 214 may be imported from the page generation system 116. In an alternative embodiment, a module or component located within the transition management system 118 may generate the pages. The transition management system 118 then automatically generates transitions between states of these pages 214.

In example embodiments, the state module 202 determines the state of a component (e.g., a product represented by a grouping of elements of the page). As such, the state module 202 determines, for each state, all the elements and their attributes (e.g., size, location, color of the elements). Additionally, the state module 202 may determine an overall size of the state based on the corresponding page. The data determined by the state module 202 may be stored to a state database 204. As such, the state database 204 will store, for each state, an identifier for the state, a list of elements, and element attributes (e.g., size, location).

The rules module 206 manages rules used to automatically generate transitions between the states. In example embodiments, the transition management system 118 automatically creates the transitions between states based on a set of rules that provides one or more transition mechanisms to be applied to the elements. For example, one rule is a path of least resistance where an element may transition in or out (e.g., with a transition mechanism such as a fly in effect or fly out effect) in a shortest direction from an edge of the state or in a direction without any other elements blocking the way. Another rule may be an introduction of a new element (e.g., fade in effect) where the element appears in a destination state. In contrast, an element in a departure state may fade out if the element is not a part of the destination state. Furthermore when an element shrinks or increases between the departure state and the destination state, a resize rule may automatically interpolate between the two sizes of the element and apply a gradual size increase or reduction accordingly. It is noted that a state display may be resized based on the overall size of the departure state corresponding to the departure page being different from the destination state.

A plurality of these rules may be established by the rules module 206 to automatically define the transitions from one state to the next. In example embodiments, default rules may be established from which a developer or other user may customize using the rules module 206. The rules may be stored to a rules database 208. These rules may then be accessed and used when automatically generating the transitions.

The transition module 210 automatically generates a transition between two states (e.g., a departure state and a destination state) based on a set of rules stored in the rules database 208. In example embodiments, the transition module 210 will receive an indication of a change in pages on a user interface. For example, a button associated with a departure page may be triggered that provides a change to a particular destination page. Thus, the indication will include information regarding the destination page. In example embodiments, the transition module 210 accesses the state database 204 and retrieves an array of size values and position coordinates for elements of the destination state based on the identity of the destination page. Using the size values and position coordinates, the transition module 210 generates the transitions. For example, the transition module 210 may decide which values/coordinates of various elements to animate using interpolation to change the elements between the two states.

The transition module 210 may also define timing based on a distance an element has to travel. For example, to transition from a small button to a size that covers 80% of a page, the transition module 210 determines coordinates of the different sizes of the button and determines an amount of time to transition between the different sizes. The resulting value may be used to set the timing (e.g., how long it will take to transition from one state to another) for the individual item (e.g., the button) or for the entire transition. In example embodiments, velocity for animation of elements is defaulted to be at a particular speed (e.g., easeout). However, the developer may customize or change the velocity. For example, assume ten elements are transitioning to different positions and sizes from a departure state to a destination state. The timing fir each element of the transition may be the same time for each element. Alternatively, a shorter time may be used for items that are departing compared to items that are entering the component or items that are already in the component but changing.

Although the various components of the transition management system 118 have been defined in terms of a variety of individual modules, a skilled artisan will recognize that many of the items can be combined or organized in other ways and that not all modules need to be present or implemented in accordance with example embodiments. Furthermore, not all components of the transition management system 118 may have been included in FIG. 2. In general, components, protocols, structures, and techniques not directly related to functions of exemplary embodiments have not been shown or discussed in detail. The description given herein simply provides a variety of exemplary embodiments to aid the reader in an understanding of the systems and methods used herein.

To better illustrate the inventive subject matter, example user interface pages will be discussed. Example embodiments retain elements that appear in both a departure state and destination state, while transitioning out elements that disappear (e.g., fly out effect, fade out effect) and transitioning in elements that appear (e.g., fly in effect, fade in effect). Thus, instead of completely removing one static page and providing a completely new static page, example embodiments provide a smooth transition between pages that allow for the user to maintain focus on particular elements. The transitions are generated automatically by the transition module 210.

Referring now to FIG. 3a, a screen shot of a results page 300 of an example user interface for a plurality of products is shown. For example, a user may search for particular products. The results of the search may be provided in the results page 300 of FIG. 3a. The results include four products whereby each product result 302 includes an image (e.g., image1, image2, image3), a product title, a brief description, and some buttons to trigger provisioning of further information or to compare. The results page 300 also includes general triggers 304 which may be found on a plurality of the user interface pages.

When a user selects the general trigger 304 labeled “small,” a screen shot of a small display page 310 for the products is provided as shown in FIG. 3b. The small display page 310 shows the product results 302 in a collapsed view whereby only the product title is visible. To transition from the results page 300 to the small display page 310, the image, brief description, and buttons transitions out (e.g., fade out effect) for each of the product results 302. A box surrounding each product result 302 resizes down and the product title moves to a center of the box for each product result 302. The general triggers remain unchanged since their size and location is unchanged when transition from the results page 300 to the small display page 310. Furthermore, the size of the small display page 310 is smaller than the results page 300. Therefore, the size of the state display resizes down.

In a further example, a user may transition from the results page 300 to a comparison page 320 shown in FIG. 3c by selecting the general trigger “compare” 304 or a “compare” button within one of the product results 302. The comparison page 320 shows the products results 302 in an elongated column that retains the image and brief description from the results page 300 of FIG. 3a, includes new feature details 322 and an enroll button 324. To transition from the results page 300 to the comparison page 320, the product title, image, and brief description transitions to their new position (e.g., move to the new position along the shortest path with a fly effect) for each of the product results 302. The “compare” and “more info” buttons of the results page 300 fade out or fly out, and the feature details 322 and an enroll button 324 fade in or fly in. Additionally, the box surrounding each product result 302 resizes into a column. The general triggers remain unchanged since their size and location is unchanged when transition from the results page 300 to the comparison page 320.

FIG. 3d is a screen shot of a full information page 330 of the example user interface for a product 1. The full information page 330 may be transitioned from any of the previously discussed pages via triggering a full information button. For example, the full information page 330 may be triggered by selecting the “more information” button for product1 (associated with the labeled product title 1 product result 302) on the results page 300. By triggering this button, the product results for product2, product3, and product 4 transition out. For example, the product result 302 for product2 and product 4 may fly out to the right while the product result 302 of product3 may fly out to the bottom of the results page 300. Some of the displayed information for product1 may then be enlarged (e.g., resize effect), moved (e.g., fly effect), or removed (e.g., fade out or fly out effect) to arrive at the full information page 330. For example, image1 may fly out to the top while a new imageA flies in from the left, Product Title 1 and the brief description move to their new locations on the full information page 330 using a fly effect. Furthermore, new information (e.g., subtitles, detailed information and check lists) may fade in or fly in from the right.

It is noted that each page shown in FIG. 3a-3d may transition to any other page. The transition module 210 will simply determine the elements in the departure state and the destination state, access rules for transitioning the elements in these states, and automatically generates the transition between the pages/states without the need for any human user interaction.

FIG. 3e is a screen shot of a page of a user interface having live communication. In one example, a communication bar 340 may move (e.g., fly effect) around seamlessly as a user moves a cursor over the page. In another example, a user may, using an input device, grab and move the communication bar 304 to a certain location. Additionally, the pointer may be separately rotated to point to a specific part of the screen. Other ways to move the communication bar 304 may include clicking on a particular screen location to move the communication bar 304 to that location or using a gestural circular movement while holding down a mouse button. In the case of a touch screen, a user may use a finger to circle an area of the screen as the input to reposition the communication bar 340 and angle a point of the communication bar 304. The communication bar 340 may, for example, allow the user to chat with a live operator. For example, when the communication bar 340 moves to an area near Question 3, and the communication bar 340 may inquire if the user needs any clarification before answering Question3. Similarly, when the communication bar 340 moves to an area near the input1 field, the communication bar 340 may provide guidance for inputting into the input1 field.

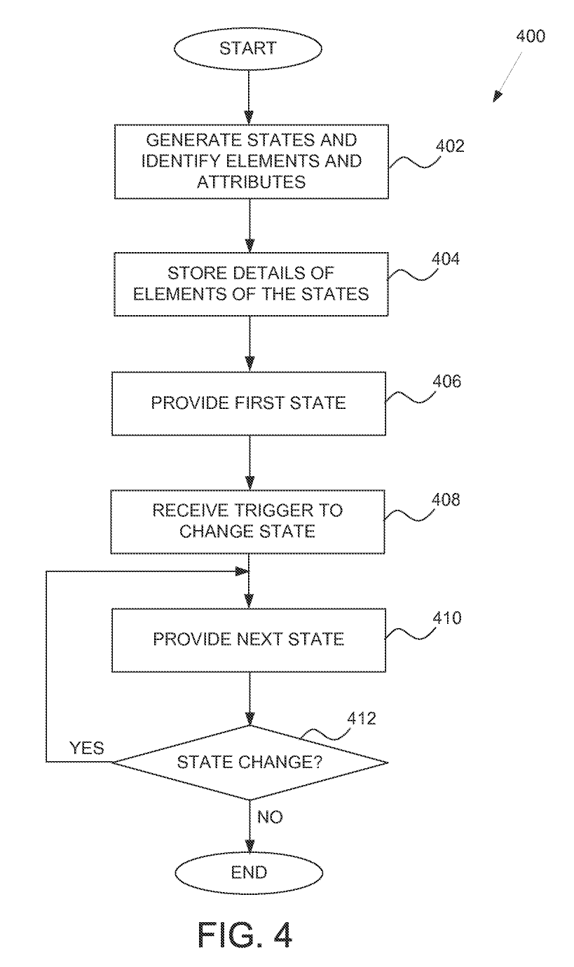

FIG. 4 is a flow diagram of an example high-level method 400 for providing object scalability and morphing in transitions according to example embodiments. In example embodiments, static pages of a user interface are used by the transition management system 118 to automatically generate transitions between the pages. In some embodiments, the pages may be imported from the page generation system 116. In an alternative embodiment, a module or component located within the transition management system 118 may generate the pages.

In operation 402, states are generated based on the received pages and elements and attributes of the pages/states are identified. In example embodiments, the state module 202 determines the state of a component (e.g., a product represented by a grouping of elements) of each page. Thus for each state, the elements and element attributes (e.g., size of each element, location of each element) is determined by the state module 202. Additionally, the state module 202 may determine an overall size of the state based on the corresponding page.

The data determined in operation 402 may be stored to a state database 204 in operation 404. As such, the state database 204 may store, for each state, a size of the state, a list of elements in the state, and attributes for each of the elements in the state (e.g., size, location). It is noted that operations 402 and 404 as well as operations directed to generating and storing rules for transitions may occur at any time before the user interface is activated (e.g., accessible to a user at the client device 106).

Once the user interface is accessible to the user at the client device 106, the client device 106 may request a first page of the user interface. In this case, a first state corresponding to the first page may be provided in operation 406. In example embodiments, a module of the transition management system 118 (e.g., transition module 210) provides the first state.

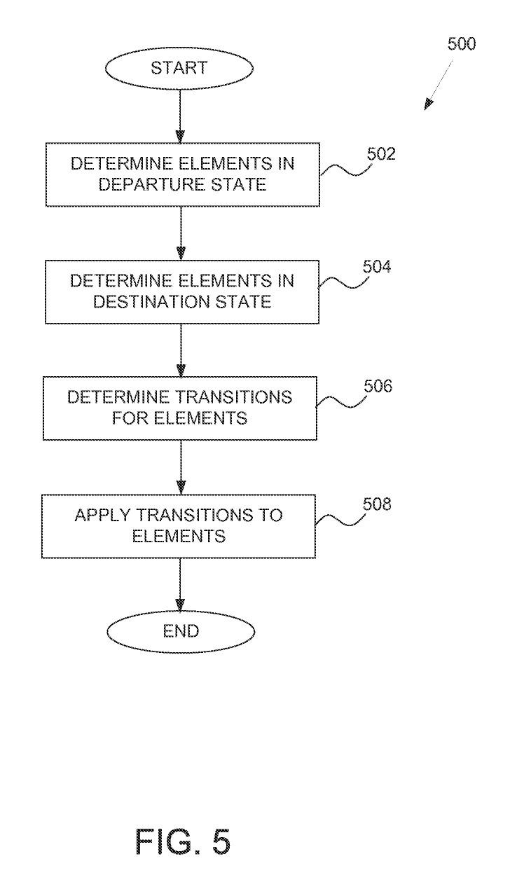

In operation 408, the transition management system 118 receives a trigger to change states. The trigger may comprise an indication of a destination page or state. In response, a next state corresponding to the destination page is provided to the client device 106 in operation 410. A discussion of a detailed method to transition to the next state will be discussed in more detail in connection with FIG. 5 below.

In operation 412, a determination is made as to whether a further state change trigger is received. If a further state change trigger is received, then the method 400 returns to operation 410 to provide the next state.

FIG. 5 is a flow diagram of an example method 500 for providing a transition to a new state. Because the transition management system 118 is aware of the first state (e.g., departure state) and the next state (e.g., destination state), the transition management system 118 may automatically generate a transition from the departure state to the destination state.

In operation 502, elements of the departure state are determined based on the identity of the departure state received with the trigger. Similarly, elements of the destination state are determined based on the identity of the destination state received with the trigger. In example embodiments, the transition module 210 takes the identity of the two states and accesses the lists of elements and their attributes (e.g., size, location coordinates) for each of these states from the state database 204 in operation 504. An overall size of each state may also be retrieved.

In operation 506, transitions for the elements are determined. In example embodiments, the transition module 210 determines which elements disappear and which elements appear when transitioning from the departure state to the destination state. The transition module 210 also determines which elements remain and where these remaining elements are located and how they are sized in the destination state. Once all the differences are determined by the transition module 210, the rules database may be accessed to determine the individual transitions to be applied to each element. For example, if an image in the departure state needs to move from a right corner to the center and increases in size, the transition module 210 accesses the rules database 208 to find the one or more rules that will apply. The rules may include, for this example, a fly-to-center effect along a shortest path while resizing at a pre-determined interval. Once all the transitions are determined for the elements, the transitions may be applied to the elements in operation 508.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations as described herein. It wilt be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time. The processor may be temporary configured or permanently configured to perform relevant operations. Whether temporarily configured or permanently configured, such processors may constitute processor-implemented modules that operate to perform one or more operations or functions.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

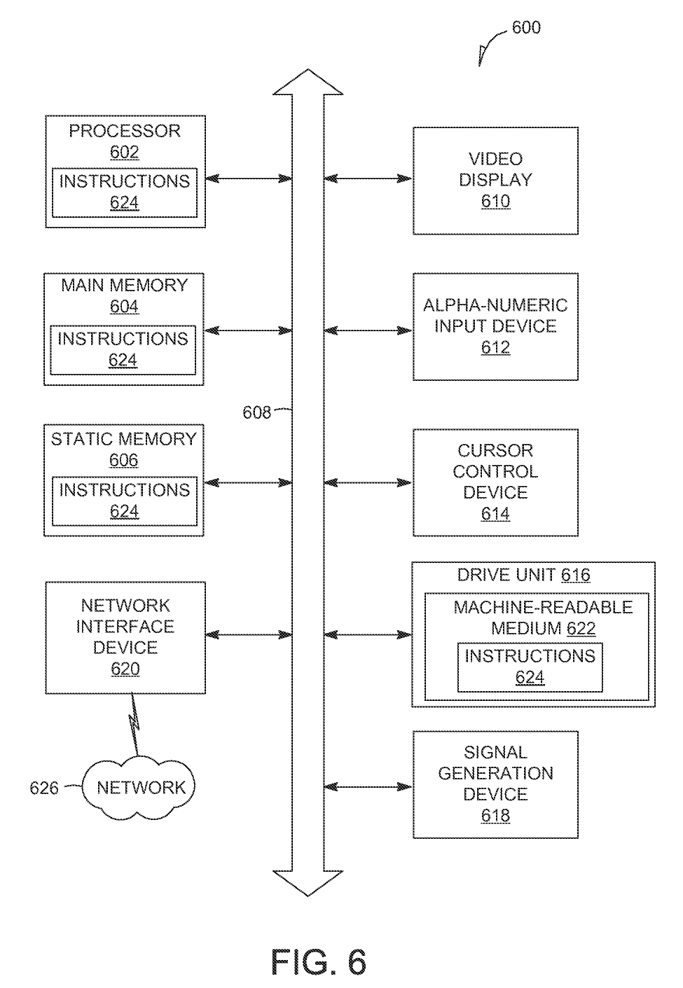

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC) a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a. bus 608. The computer system 600 may further include a video display unit 610 (e.g., a liquid crystal display (LCD) or a cathode ray tube (CRT)). In example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker) and a network interface device 620.

### Machine-Readable Storage Medium

The disk drive unit 616 includes a machine-readable storage medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, with the main memory 604 and the processor 602 also constituting machine-readable media.

While the machine-readable storage medium 622 is shown in an example embodiment to be a single medium, the term “machine-readable storage medium” may include a single medium or multiple media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually, or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. As used herein, the term “or” may be construed in either an inclusive or exclusive sense. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a request to transition from a departure state of a first page of a user interface to a destination state of a second page of the user interface;
identifying a plurality of elements and element attributes within the departure state and the destination state;
determining, for each of the elements, a transition mechanism to be applied to an element to transition to the destination state; and
automatically generating, using a processor of a machine, the transition to the destination state by applying, for each of the elements, the determined transition mechanism.

2. The method of claim 1, wherein the identifying the plurality of elements and element attributes comprises accessing a state database storing a list of elements and element attributes for each state of the user interface.

3. The method of claim 1, wherein the determining the transition mechanism comprises accessing a rules database that include rules for transitioning the element to the destination state.

4. The method of claim 3, further comprising allowing a user to modify application of a rule from the rules database.

5. The method of claim 1, further comprising:
receiving a plurality of pages of the user interface including the first page and the second page;
analyzing the pages to determine the plurality of elements and the element attributes for each state of the plurality of pages; and
storing the plurality of elements and the element attributes to a state database.

6. The method of claim I, wherein the transition mechanism comprises a selection from the group consisting of a fly effect, a fade effect, a resize effect, a bold effect, and a font change effect to be applied to the element.

7. The method of claim 1, wherein the transition mechanism comprises a resize of a state display based on an overall size of the departure state being different from an overall size of the destination state.

8. The method of claim 1, wherein the element attributes comprises a location and size for each of the elements.

9. A machine-readable storage medium in communication with at least one processor, the machine-readable storage medium storing instructions which, when executed by the at least one processor of a machine, causes the machine to perform operations comprising:
receiving a request to transition from a departure state of a first page of a user interface to a destination state of a second page of the user interface;
identifying a plurality of elements and element attributes within the departure state and the destination state;
determining, for each of the elements, a transition mechanism to be applied to an element to transition to the destination state; and
automatically generating the transition to the destination state by applying, for each of the elements, the determined transition mechanism.

10. The machine-readable storage medium of claim 9, wherein the identifying the plurality of elements and element attributes comprises accessing a state database storing a list of elements and element attributes for each state of the user interface.

11. The machine-readable storage medium of claim 9, wherein the determining the transition mechanism comprises accessing a rules database that include rules for transitioning the element to the destination state.

12. The machine-readable storage medium of claim 11, wherein the operations further comprise allowing a user to modify application of a rule from the rules database.

13. The machine-readable storage medium of claim 9, wherein the operations further comprise:
receiving a plurality of pages of the user interface including the first page and the second page;
analyzing the pages to determine the plurality of elements and the element attributes for each state of the plurality of pages; and
storing the plurality of elements and the element attributes to a state database.

14. The machine-readable storage medium of claim 9, wherein the transition mechanism comprises a selection from the group consisting of a fly effect, a fade effect, a resize effect, a bold effect, and a font change effect to be applied to the element.

15. The machine-readable storage medium of claim 9, wherein the transition mechanism comprises a resize of a state display based on an overall size of the departure state being different from an overall size of the destination state.

16. The machine-readable storage medium of claim 9, wherein the element attributes comprises a location and size for each of the elements.

17. A system comprising:
at least one processor of a machine; and
a transition module to
receive a request to transition from a departure state of a first page of a user interface to a destination state of a second page of the user interface;
identify a plurality of elements and element attributes within the departure state and the destination state;
determine, for each of the elements, a transition mechanism to be applied to an element to transition to the destination state; and
automatically generate, using the processor of the machine, the transition to the destination state by applying, for each of the elements, the determined transition mechanism.

18. The system of claim 17, wherein the plurality of elements and element attributes are identified by accessing a state database storing a list of elements and element attributes for each state of the user interface.

19. The system of claim 17, further comprising a rules module to maintain a rules database that include rules for transitioning the element to the destination state, the rules for transition indicating the transition mechanism to be applied.

20. The system of claim 17, further comprising a state module to:
receive a plurality of pages of the user interface including the first page and the second page;
analyze the pages to determine the plurality of elements and the element attributes for each state of the plurality of pages; and
store the plurality of elements and the element attributes to a state database.
